(19) United States
(12) Patent Application Publication
(10) Pub. No.: US 2021/0324818 A1
(43) Pub. Date: Oct. 21, 2021

(54) CHILLDOWN DEVICE AND METHOD

(71) Applicant: ARIANEGROUP SAS, PARIS (FR)

(72) Inventor: Davide DURI, PRESSAGNY L'ORGUEILLEUX (FR)

(73) Assignee: ARIANEGROUP SAS, PARIS (FR)

(21) Appl. No.: 16/336,495

(22) PCT Filed: Sep. 28, 2017
(86) PCT No.: PCT/FR2017/052644

§ 371 Date: Mar. 26, 2019

(30) Foreign Application Priority Data
Sep. 30, 2016 (FR) 1659413

(51) Int. Cl. F02K 9/97; F02K 9/48; F02K 9/56; F02K 9/60; F04D 25/02; F04D 29/58

(52) U.S. Cl. CPC F02K 9/972; F02K 9/48; F02K 9/56; F05D 2260/201; F04D 25/024; F04D 29/5886; F02K 9/60

(57) ABSTRACT

The invention relates to the field of cryogenics, and in particular to a device and a method for chilling down a cryogenic system (1). The chilldown device (100, 101) comprises a cryogenic fluid feed circuit (102, 103) and at least one atomizing nozzle (110) connected to said feed circuit (102, 103). The chilldown method includes feeding cryogenic fluid via a feed circuit (102, 103) to at least one atomizing nozzle (110) connected to the feed circuit (102, 103), spraying the cryogenic fluid through the at least one atomizing nozzle (110) as a spray (200) of cryogenic fluid, and projecting the spray (200) of cryogenic fluid against at least one zone to be cooled in the cryogenic system (1).

### BACKGROUND OF THE INVENTION

The present invention relates to the field of chilling down cryogenic systems, and in particular cryogenic propulsion systems.

Before putting a cryogenic system into operation, it is known to perform a chilldown stage during which at least the critical members of the cryogenic system are taken from ambient temperature to the nominal operating temperature for the cryogenic system, with this normally being done gradually so as to avoid any thermal shock when putting the cryogenic system in operation.

More specifically, in a cryogenic propulsion system, chilldown may seek to avoid the appearance of at least the following phenomena:
cavitation in at least one cryogenic propellant feed pump, leading to excess speed of the pump and to a drop in performance;
embrittlement of the materials as a result of thermal shocks;
a loss of sealing due to uncontrolled thermal gradients;
bearings heating and diverging; and
static and/or dynamic unbalancing of rotary parts, resulting from slack in the bearings.

Thus, such chilldown is normally finalized when certain optional criteria are satisfied, such as for example a wall temperature, a clearance threshold between the mechanical components, or some other criterion associated with the mechanical strength of components such as, among others: bearings, flanges, draw bars, or fluting, or with the subsequent operation of the cryogenic system (e.g. no cavitation in the pump, or subsequent reproducible filling of portions of the cryogenic system with a cryogenic operating fluid that is uniform and comprises a single phase). These functional criteria may be transposed into criteria that can be measured at the end of chilldown for use by monitoring software in order to allow the cryogenic system to be put into operation.

In the field of cryogenic jet propulsion systems, chilldown methods are classified mainly in three classes: chilldown by draining with cryogenic propellant, chilldown by forced recirculation of cryogenic propellant, and chilldown with a cryogenic fluid other than a propellant. Of these three classes, the first, in which the flow of cryogenic propellant may be driven merely by the propellant tank being at a higher pressure than the outside, is the most widespread and in particular it can be implemented using any one of the following three alternative sequences:
causing the cryogenic propellant to flow continuously from the tank to the outside;
causing the cryogenic propellant to flow in pulses, in which the feed valves and the drain valves are opened and closed in alternation in order to trap the cryogenic propellants in the elements that are to be chilled down during periods of bubbling;
causing the cryogenic propellant to percolate, in which the feed valves are opened while the drain valves remain closed, so as to keep the cryogenic propellant in the cryogenic system until the drain valves are opened at the end of chilldown.

Of those three sequences, the first, even though it is very fast, presents the drawback of consuming a large quantity of cryogenic propellant for chilldown purposes. The second, even though it enables chilldown to be performed while consuming less cryogenic propellant, presents the drawback of giving rise to large variations of pressure in the cryogenic system. The third is used in particular, in flight, for chilling down Vinci® rocket engines, as described in the article “Progress of the Vinci engine system engineering”, P. Alliot et al., AIAA 2009-5038, and “Microgravity activities for the Vinci engine reignition capability”, A. Pacros, J. Follet, and B. Veille, Proceedings of the Microgravity Transport Processes in Fluids, Thermal, Biological and Material Sciences III, 2003, Davos, Switzerland. Although it is less expensive in terms of cryogenic propellant than the first sequence, and although it lacks the drawback of pressure fluctuations of the second sequence, this third sequence nevertheless involves considerable consumption, which needs to be reduced.

Thus, in order to avoid consuming cryogenic propellant for chilldown purposes, in chilldown methods of the second class, the cryogenic propellant is caused, by means of a pump, to recirculate through zones of the cryogenic system that is to be chilled down prior to returning to the tank. Although that serves to avoid consuming cryogenic propellant for chilldown purposes, that solution presents the drawback of being technically more complex, and in particular of requiring means for actuating the pump.

Finally, chilldown methods in the third class avoid consuming cryogenic propellant by making use instead of some other cryogenic fluid, preferably an inert fluid, for chilling down the cryogenic system. When chilldown takes place on the ground, the other cryogenic fluid may come from tanks on the ground. One such example is disclosed in the article “Cold flow testing of revised engine chilldown methods for the Atlas Centaur”, by J. Schuster et al., AIA 96-3014. That solution nevertheless presents the drawback of requiring a releasable interface between the source of cryogenic fluid on the ground and the cryogenic space propulsion system on board the propelled vehicle.

Furthermore, all of those alternatives suffer from the drawback of causing the cryogenic fluid that is used for chilldown purposes to flow generally in the same pipes and valves as are used subsequently for conveying propellant while the cryogenic propulsion system is in operation, which pipes and valves are optimized as a function of use for propulsion and not for chilldown purposes.

Above all, the predominant mode of heat transfer in all of those methods is that of film boiling, which is relatively ineffective under such conditions since a considerable portion of the cryogenic fluid used does not come directly into contact with the elements to be cooled and therefore contributes little to that transfer of heat.

### OBJECT AND SUMMARY OF THE INVENTION

The present disclosure seeks to remedy those drawbacks, by proposing a chilldown device that makes it possible to chill down a cryogenic system with limited consumption of cryogenic fluid, by enabling both the duration of cooling and the location in space of the cooling action to be both controlled and reproducible.

For this purpose, in at least one embodiment, the chilldown device includes at least one cryogenic fluid feed circuit and an atomizing nozzle connected to said feed circuit, the atomizing nozzle possibly being in the form in particular of an orifice having a diameter, e.g. lying in the range 250 micrometers (μm) to 1 millimeter (mm). By means of this provision, it is possible to direct a spray of cryogenic fluid against a defined zone to be cooled in the cryogenic system so as to target specifically elements that it is critical to cool in the cryogenic system, such as for example ball bearings, and to take advantage of the particularly effective transfer of heat between such a spray and an impact surface in the zone to be cooled, so as to satisfy quickly all of the functional and measurable criteria for chilling down while using very little cryogenic fluid and technical means that are simple. The chilling down of said critical elements can thus be given priority and the duration of chilldown can be shortened because of the improved effectiveness of heat transfer.

In order to be able to simultaneously target a plurality of zones to be cooled, the chilldown device may include a plurality of atomizing nozzles connected to said feed circuit.

In order to integrate the chilldown device better in the cryogenic system, at least one duct of said cryogenic fluid feed circuit may be formed in a casing wall. Specifically, such integration serves to limit the overall size of the chilldown device while providing a particularly functional configuration for the atomizing nozzle. Embedded in the bulk of the casing wall, the cryogenic fluid feed duct need not interfere with the arrangement of any other element of the cryogenic system. Possible use of additive fabrication for making the casing wall can serve to facilitate incorporating the feed duct in this way in the casing wall.

The present disclosure also provides a cryogenic system including such a chilldown device. In particular, in order to target better a zone to be cooled in the cryogenic system, the atomizing nozzle may be situated facing that zone to be cooled. The cryogenic system, which may in particular be a cryogenic propulsion system, and above all a jet propulsion system, may include a pump, and in particular a turbopump and/or a cryogenic propellant feed pump, in which said zone to be cooled is located. Specifically, such pumps may include certain elements that need to be chilled down as a priority, such as bearings, gaskets, blades, casings, and impellers.

Finally, the present disclosure also provides a method of chilling down a cryogenic system, the method comprising: feeding cryogenic fluid via a feed circuit through at least one atomizing nozzle connected to the feed circuit, spraying the cryogenic fluid through at least one atomizing nozzle so as to form a spray of cryogenic fluid, and projecting the spray of cryogenic fluid against at least a zone to be cooled in the cryogenic system.

### BRIEF DESCRIPTION OF THE DRAWINGS

The invention can be well understood and its advantages appear better on reading the following detailed description of an embodiment given by way of non-limiting example. The description refers to the accompanying drawings, in which:

FIG. 1 is a diagrammatic view of a cryogenic jet propulsion system;

FIG. 2 is a longitudinal section view through a turbopump for feeding cryogenic propellant in the FIG. 1 cryogenic system, having a casing including a chilldown device in a first embodiment of the invention;

FIG. 3 is a detail view of elements of the chilldown device and of a feed duct of the FIG. 2 turbopump; and

FIG. 4 is a diagram showing the effect of a cryogenic fluid spray delivered by a nozzle of the FIG. 2 chilldown device onto a surface that is to be cooled.

### DETAILED DESCRIPTION OF THE INVENTION

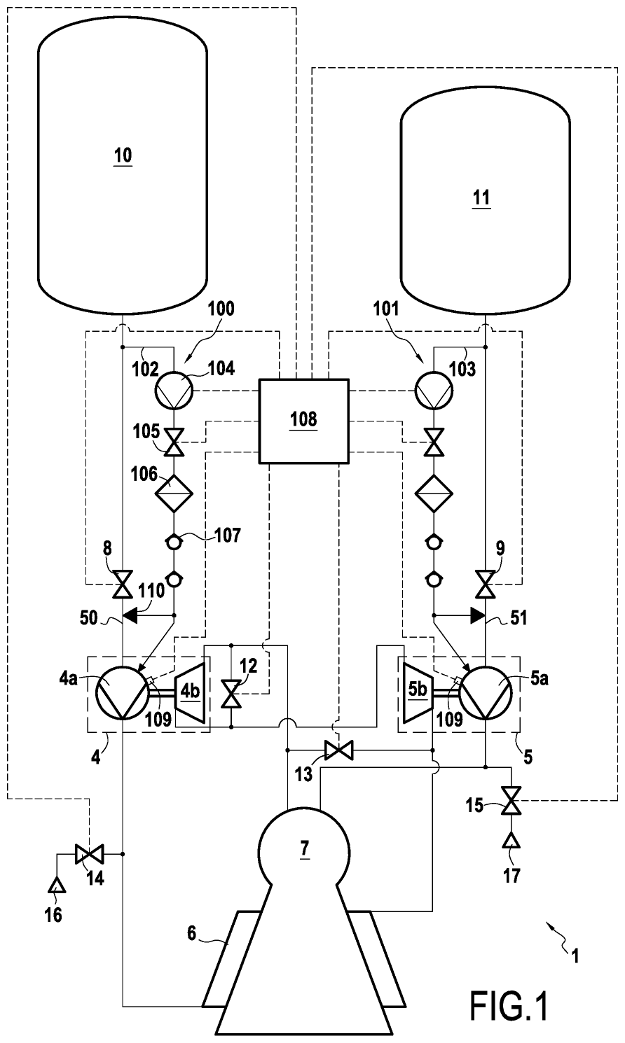

The chilldown device of the present invention is applicable to chilling down any cryogenic system, but particularly to chilling down cryogenic propulsion systems, and more particularly to chilling down cryogenic jet propulsion systems, e.g. such as the rocket engine 1 shown in FIG. 1. In the embodiment shown, the rocket engine 1 is a rocket engine fed with cryogenic liquid propellants, e.g. such as liquid hydrogen and liquid oxygen, by means of turbopumps 4 and 5, each having a pump portion 4a, 5a for delivering a flow of one of the propellants, and a turbine portion 4b, 5b coupled to the corresponding pump portion 4a, 5a in order to drive it. More specifically, the rocket engine 1 shown is of the expander cycle type in which the turbine portions 4b, 5b are themselves driven by one of the propellants after it has passed through a regenerative heat exchanger 6 adjacent to the walls of the propulsion chamber 7 of the rocket engine 1. Feed valves 8, 9 are interposed between the tanks 10, 11 containing the propellants and the corresponding turbopumps 4, 5, and bypass valves 12, 13 serve to allow the propellants heated by the heat exchanger 6 to bypass, at least in part, the turbine portions 4b, 5b. Finally, drain valves 14, 15 situated on branch connections downstream from each pump portion 4a, 4b serve to open those branch connections in order to drain fluid that has passed upstream through the pumps 4a, 5a via those branch connections leading to drain nozzles 16, 17. Nevertheless, the invention is not limited in any way to chilling down such rocket engines, and may be applied to chilling down other types of cryogenic system for jet propulsion, and even to other cryogenic systems in general.

In order to chill down the cryogenic propulsion system, and more specifically in order to chill down the pump generators 4a, 5a of the turbopumps 4, 5 that are to come directly into contact with the corresponding cryogenic propellant while the rocket engine 1 is in operation, the rocket engine 1 has two chilldown devices 100, 101, one for each propellant, each comprising a feed circuit 102, 103 connected to the corresponding tank 10, 11. Each feed circuit 102, 103 has a pump 104, a valve 105, a filter 106, and at least one check valve 107. The pumps 104 may in particular be motor-driven pumps driven by electric motors, as shown. Furthermore, the pumps 104 and valves 105, like the feed valves 8, 9, the bypass valves 12, 13, and the drain valves 16, 17, may themselves be connected to a control unit 108 for control purposes. The control unit 108 is also connected to sensors 109 that may in particular be temperature sensors, suitable for measuring physical parameters suitable for use as measurable chilldown criteria.

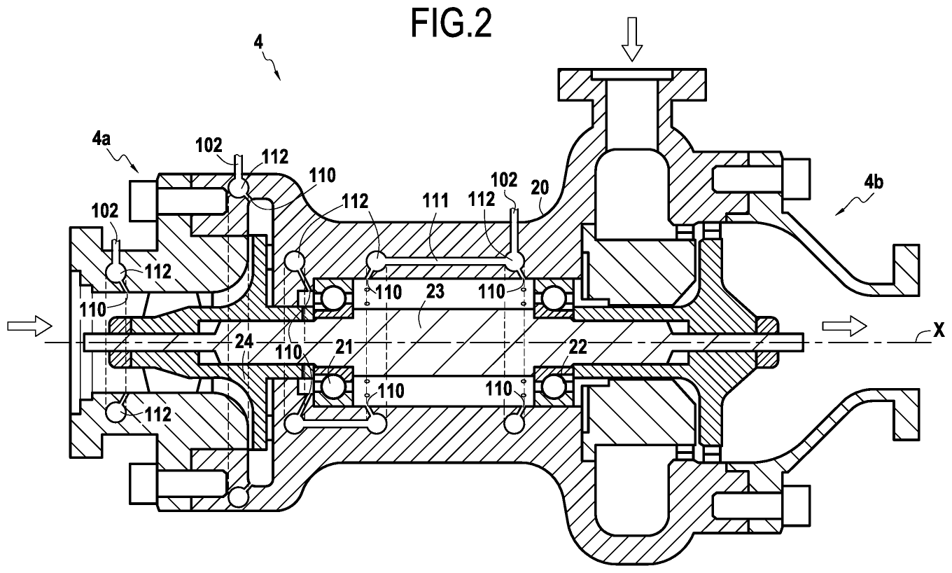

The chilldown devices 100, 101 also have atomizing nozzles 110 connected to the corresponding feed circuits 102, 103. In the embodiment shown, the atomizing nozzles 110 are situated in the turbopumps 4, 5. FIG. 2 shows the turbopump 4 in greater detail. As can be seen in this figure, the feed circuit 102 also has feed ducts integrated in the casing 20 of the turbopump 4, being connected to the circuit 102 and leading to atomizing nozzles 110 in the proximity of specific elements of the pump portion 4a of the turbopump 4 that is to be cooled down when put into operation. More specifically, in the embodiment shown, the atomizing nozzles 110 are distributed around the central axis X of the turbopump 4, facing bearings 21, 22 that support the rotary shaft 23 of the turbopump 4, and also directly upstream and downstream from the impeller 24 of the pump portion 4a.

In this embodiment, the casing 20 may be produced by additive fabrication, thus making it easier to integrate the feed ducts in the casing 20 where they are embedded in the walls of the casing 20. These feed ducts may be annular, in particular for the purpose of feeding cryogenic fluid to a plurality of atomizing nozzles 110 distributed around the central axis X of the turbopump 4, and they may also be axial, i.e. parallel to the central axis X, so as to feed a plurality of rings of atomizing nozzles 110 that are axially offset relative to one another. For example, in the embodiment shown, an axial feed duct 111 connects together two annular feed ducts 112 for feeding rings of atomizing nozzles 110 situated facing the two bearings 21 and 22. The diameter d of the atomizing nozzles 110 may be optimized as a function of the size desired for the droplets of cryogenic fluid to be ejected through the atomizing nozzles 110. By way of example, this diameter d may lie in the range 250 μm to 1 mm. Although FIG. 2 shows only the turbopump 4 and a portion of the chilldown device 100 for the corresponding propellant, the chilldown device 101 for the other propellant may be essentially analogous, likewise incorporating feed ducts and atomizing nozzles within the casing of the turbopump 5.

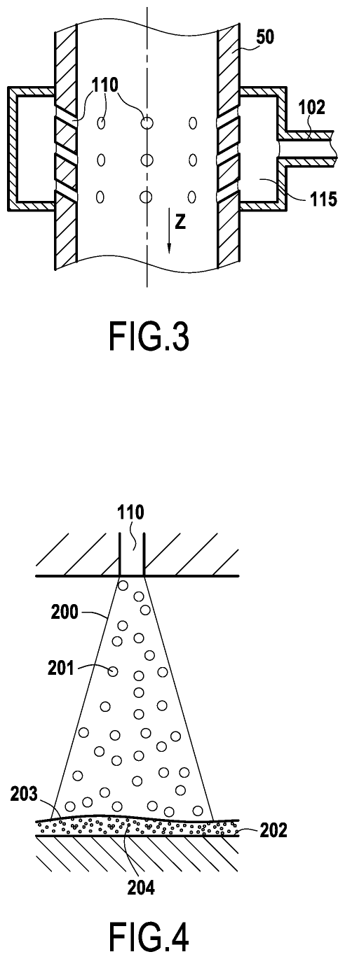

Although the atomizing nozzles 110 in the turbopumps 4 and 5 face directly specific zones to be cooled when chilling down, it is also possible to envisage incorporating atomizing nozzles 110 elsewhere. Thus, in the embodiment shown, other atomizing nozzles 110 of the chilldown devices 100, 101 are situated upstream from the corresponding turbopumps 4, 5 in the feed ducts 50, 51 of the pump portions 4a, 5b of those turbopumps 4, 5. The feed duct 50 is shown in greater detail in FIG. 3. As can be seen in this figure, the atomizing nozzles 110 in this feed duct 50 are in communication with the feed circuit 102 via an annular chamber 115 formed around the admission duct 50. In the embodiment shown, these atomizing nozzles 110 slope downstream towards the inside of the feed duct 50 so as to direct their sprays in this downstream direction Z of the feed duct 50. Furthermore, in order to enable a greater total flow rate of cryogenic fluid to be injected, a plurality of annular rings of atomizing nozzles 110 may be arranged that are offset from one another along the central axis of the admission duct 50, as shown. Although FIG. 3 shows only the admission duct 50 of the first turbopump 4, the chilldown device 101 for the other propellant may have an essentially analogous arrangement around the feed duct 51 of the second turbopump 5.

In operation, in order to chill down both turbopumps 4 and 5, the respective chilldown devices 100, 101 are activated by the control unit 108, activating the pumps 104 and opening the valves 105, so as to cause cryogenic propellants to flow from the tanks 10, 11 and through the respective circuits 102, 103 to the atomizing nozzles 110. As shown in FIG. 4, the cryogenic fluid that is thus injected into the core of each turbopump 4, 5 through the atomizing nozzles 110 forms a two-phase jet 200 of vapor and of very small droplets 201 that strike against surfaces 202 of the zones to be cooled, so as to form a fine liquid layer 203 on those surfaces 202. By boiling, this fine liquid layer 203 absorbs a large quantity of heat from the surface 202. New droplets 201 of the jet 200 impacting against the liquid layer 203 further encourage nucleation and the removal of bubbles of vapor 204 in the liquid layer 203, and also convection within that liquid layer 203, so as to remove even more heat from the surface 202. It is thus possible to obtain very effective cooling of the surface 202 and of the underlying material, as a result of the essentially complete vaporization of the cryogenic fluid used for this chilldown operation. Downstream from the turbopumps, the drain valves 14 and 15 are open so as to discharge the resulting vapor through the drain nozzles 16, 17. When the control unit 108 determines from the parameters measured by the sensors 113 that predetermined chilldown criteria have been satisfied, the pumps 104 may be stopped, and the valves 105 and also the drain valves 14, 15 may be closed, so as to proceed subsequently with opening the feed valves 8, 9 and delivering propellant initially driven by the internal pressure in the tanks 10, 11 into the propulsion chamber 7 of the rocket engine 1. Igniting the mixture of propellants in the propulsion chamber 7 then produces combustion that continues to be fed with propellant by means of the turbopumps 4, 5 driven by the expansion of the propellant heated in the regenerative heat exchanger 6 adjacent to the walls of the propulsion chamber 7.

The chilldown devices may be designed, and their atomizing nozzles may be located on the basis of knowledge available about spray cooling, e.g. as set out in the following documents: “A universal approach to predicting temperature response of metallic parts to spray quenching”, I. Urawar and T. Deiters, International Journal of Heat and Mass Transfer, Vol. 37, No. 3, pp. 341-362, 1994, “Validation of a Systematic Approach to Modelling Spray Quenching of Aluminum Alloy Extrusions, Composites and Continuous Castings”, D. D. Hall, L. Mudawar, R. E. Morgan and S. L. Ehlers, JMEPEG (1997) 6:77-92, “Modelling of Heat Transfer in a Mist/Steam Impinging Jet”, X. Li, J. L. Gaddis, T. Wang, Transactions of the ASME 1086, Vol. 123, December 2001, “Spray Cooling Droplet Impingement Model”, P. J. Kreitzer and J. M. Kuhlman, AIAA 2010-4500, 10^{th} AIAA/ASME Joint Thermophysics and Heat Transfer Conference, 28 Jun.-1 Jul. 2010, Chicago, Ill., US, “Analytical and computational methodology for modeling spray quenching of solid alloy cylinders”, N. Mascarenhas, I. Mudawar, International Journal of Heat and Mass Transfer, 53 (2010) pp. 5871-5883, “An Experimental and Computational Study of the Fluid Dynamics of Dense Cooling Air-Mists”, J. I. Minchaca M., A. H. Castillejos E. and F. A. Acosta G. Advanced Fluid Dynamics, “Spray Cooling”, Z. Yan, R. Zhao, F. Duan, T. N. Wong, K. C. Toh, K. F. Choo, P. K. Chan and Y. S. Chua, “Two-Phase Flow, Phase Change and Numerical Modelling”, 2011, “Spray Cooling for Land, Sea, Air and Space-Based Applications, a Fluid-Management System for Multiple Nozzle Spray Cooling and a Guide to High-Heat Flux Theater Design”, B. S. Glassman, Florida Institute of Technology, 2001, “Gravity Effect on Spray Impact and Spray Cooling”, T. Gambaryan-Roisman, O. Kyriopoulos, I. Roisman, P. Stephan and C. Tropea, Z-Tec Publishing, Bremen, Microgravity sci. technol. XIX-3/4 (2007), “Spray Cooling in Terrestrial and Simulated Reduced Gravity”, C. A. Hunnell, J. M. Kuhlman and D. D. Gray, “Design of a Microgravity Spray Cooling Experiment”, K. M. Baysinger, K. L. Yerkes, T. E. Michalak, R. J. Harris, J. McQuillen, AIAA Paper 2004-0966, 42^{nd} AIAA Aerospace Sciences Conference and Exhibit, 5-8 Jan. 2004, Reno, Nev., US, “Analysis of heat transfer in spray cooling systems using numerical simulations”, M. Jafari, Electronic Theses and Dissertations, Paper 5028, 2014, “An Experimental Study of Steady-State High Heat Flux Removal Using Spray Cooling”, J. B. Fillius, Naval Postgraduate School, December 2004, Monterey, Calif., US, “Experimental investigation of droplet dynamics and heat transfer in spray cooling”; W. Jia and H. H. Qiu, Experimental Thermal and Fluid Science, 27(2003) 829-838, “Spray velocity and drop size measurements in flashing conditions”, R. Lecourt, P. Barricau and J. Steelant, Atomization and Spray 19(2):103-133, 2009, “Experimental and theoretical study of a monodisperse spray”, J. E. Kirwan, T. A. Lee at al., J. Propulsion, Vol. 4, No. 4, July-August 1988, “Fundamental studies in blow-down and cryogenic cooling”, L. C. Chow and al., Report WL-TR-932128, Aeropropulsion and power directorate, Wright Laboratory, 1993.

Although the present invention is described with reference to a specific embodiment, it is clear that various modifications and changes may be undertaken to those examples without going beyond the general ambit of the invention as defined by the claims. In addition, individual characteristics of the various embodiments mentioned may be combined in additional embodiments. Consequently, the description and the drawings should be considered in a sense that is illustrative rather than restrictive.

1. A chilldown device for chilling down a cryogenic system, said chilldown device comprising a cryogenic fluid feed circuit and at least one atomizing nozzle connected to said feed circuit in order to direct a spray of cryogenic fluid against an impact surface in a zone to be cooled in the cryogenic system.

2. The chilldown device according to claim 1, wherein the atomizing nozzle is in the form of an orifice with a diameter lying in the range 250 μm to 1 mm.

3. The chilldown device according to claim 1, wherein the at least one atomizing nozzle includes a plurality of atomizing nozzles connected to said feed circuit.

4. The chilldown device according to claim 1, wherein at least one duct of said cryogenic fluid feed circuit is formed in a casing wall.

5. The chilldown device according to claim 4, wherein said casing wall is made by additive fabrication.

6. A cryogenic system including the chilldown device according to claim 1.

7. The cryogenic system according to claim 6, wherein said atomizing nozzle is situated facing a zone to be cooled in the cryogenic system.

8. The cryogenic system according to claim 7, said cryogenic system comprising a cryogenic pump in which said zone to be cooled is situated.

9. The cryogenic system according to claim 8, said cryogenic pump being a cryogenic propellant feed pump.

10. The cryogenic system according to claim 8, said cryogenic pump being a turbopump.

11. A method of chilling down a cryogenic system, the method comprising:
feeding cryogenic fluid via a feed circuit through at least one atomizing nozzle connected to the feed circuit;
spraying the cryogenic fluid through at least one atomizing nozzle so as to form a spray of cryogenic fluid; and
projecting the spray of cryogenic fluid against at least one impact surface in a zone to be cooled in the cryogenic system.
